(19) United States
(12) Patent Application Publication
(10) Pub. No.: US 2009/0069046 A1
(43) Pub. Date: Mar. 12, 2009

(54) VIRTUAL PAPER READING DEVICE

(76) Inventors: Chien-Kun Liu, Taipei Hsien (TW); Chien-Hung Liu, Taipei (TW)

Correspondence Address: Chien-Kun Liu, 235 Chung- Ho, Box 8-24, Taipei, 235, TW

(21) Appl. No.: 11/853,845

(22) Filed: Sep. 12, 2007

(51) Int. Cl. H04B 1/38

(52) U.S. Cl. 455/557

(57) ABSTRACT

A virtual paper reading device comprises a virtual paper reading device for viewing a document from a screen through a mobile device; wherein the document to be read has a size as an original size and an original printed page; a 3 axial sensor in the mobile device for sensing moving direction of the mobile device; a key set for adjusting a size of the document to be presented and a present area of the document to be presented; and an application software for receiving the moving direction message from the 3 axial sensor and adjusting signals from the key set so as to adjust a present area and a size of the document to be presented on the screen of the mobile device. The user can read the message from the document easily and conveniently.

### FIELD OF THE INVENTION

The present invention relates to a virtual paper reading device, wherein a mobile device has a 3 axial sensor which can detect the movement of the mobile device in various directions such as upward, downward, leftward, rightwards, forward, and backward movements, and key inputting signals are used to adjust the size, zoom, and reading area of a document to be presented by using an application software.

### BACKGROUND OF THE INVENTION

The prior art mobile devices cause the user to download the image and texts for viewing, such as receiving visual radio service. The user can read the information about the playing songs or messages of actors, or enjoying on-line games, or download news from networks, stock prices, etc. However, the mobile device is limited to the size of the screen so that the texts are too small to be viewed comfortably. As a result, the user does not like the read message from the screen of the mobile device and thus they read them from the printed paper documents. However, this induces the waste of papers and thus the function of the mobile device is greatly reduced.

### SUMMARY OF THE INVENTION

Accordingly, the primary object of the present invention is to provide a virtual paper reading system which provide a virtual paper with the original printed page so that the user can read the message from the document easily and conveniently.

To achieve above object, the present invention provides a virtual paper reading system which supports a paperless reading way; the system comprises a virtual paper reading device for viewing a document from a screen through a mobile device; wherein the document to be read has a size as an original size and an original printed page; a 3 axial sensor in the mobile device for sensing moving direction of the mobile device; a key set for adjusting a size of the document to be presented and a present area of the document to be presented; and an application software for receiving the moving direction message from the 3 axial sensor and adjusting signals from the key set so as to adjust a present area and a size of the document to be presented on the screen of the mobile device.

The features of the present invention will be described herein.

Firstly, all the documents are transferred to an image file format (such as JPEG) to be stored in a memory of a mobile device.

Secondly the moving directions of the mobile device and key inputting are used to read the content of image documents in the memory of the mobile device.

The moving direction of the mobile device and key inputting are used to control the size and reading area of the document to be read and displayed on the screen of the mobile device.

The moving directions of the mobile device and key inputting are used to provide a multi-functional user interface and virtual display frame to users without the limitation of the direction, for example, the user can start, stop or pause the reading operation. The operation is easily, conveniently, and user friendly.

The zoom of the screen can be expanded or reduced, or the setting of the document to be read can be changed. The virtual paper reading system operates the direction operation for adjusting the size, contrast and illumination of the presented document so as to have a preferred effect in viewing a document clearly and quickly without being confined by the visual ability of the user.

Furthermore the present invention can be used with music or sound files so that the user can hear the content of the presented document or hear the background music.

The various objects and advantages of the present invention will be more readily understood from the following detailed description when read in conjunction with the appended drawing.

### BRIEF DESCRIPTION OF THE DRAWINGS

FIG. 1 is a schematic view about a preferred embodiment of the present invention.

FIG. 2 shows another schematic view about the preferred embodiment of the present invention.

FIG. 3 is a further schematic view about the preferred embodiment of the present invention.

FIG. 4 shows a still schematic view about the preferred embodiment of the present invention.

### DETAIL DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention is related to a virtual paper reading system. The documents of various sizes can be viewed through a virtual paper which may be a daily newspapers, commercial reports, electronic books, papers, photographers, documents of various forms. The documents can be downloaded through a computer or from a network and then the documents are stored in a memory of a mobile device. A handset can get a document from a network or a short message. The documents can be read as an original paper having the original printed page and zoom.

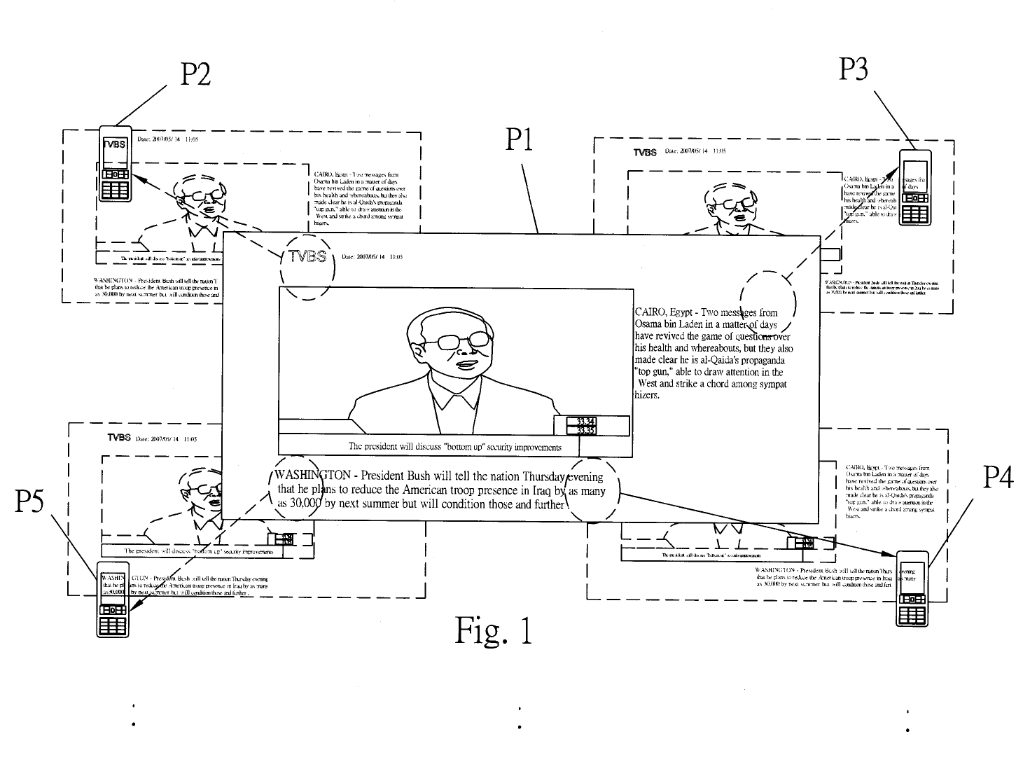

Referring to FIG. 1, the present invention has the following steps.

P1: viewing a virtual printed page.

P2. The handset moves to a left upper side of the document and then the screen of the handset will display the content of the document at a corresponding position (left upper side of the document).

P3. The handset moves to a right upper side of the document and then the screen of the handset will display the content of the document at a corresponding position (right upper side of the document).

P4. The handset moves to a right lower side of the document and then the screen of the handset will display the content of the document at a corresponding position (right lower side of the document).

P5. The handset moves to a left lower side of the document and then the screen of the handset will display the content of the document at a corresponding position (left lower side of the document).

Thus the screen of the handset will display a corresponding position of the document for being read by users.

Due to the convenience of the mobile device and networking, the virtual paper reading device may present a document at any place with a real size as the size of the original document.

Furthermore in the present invention, the size of the document is adjustable as viewing the images from a digital camera.

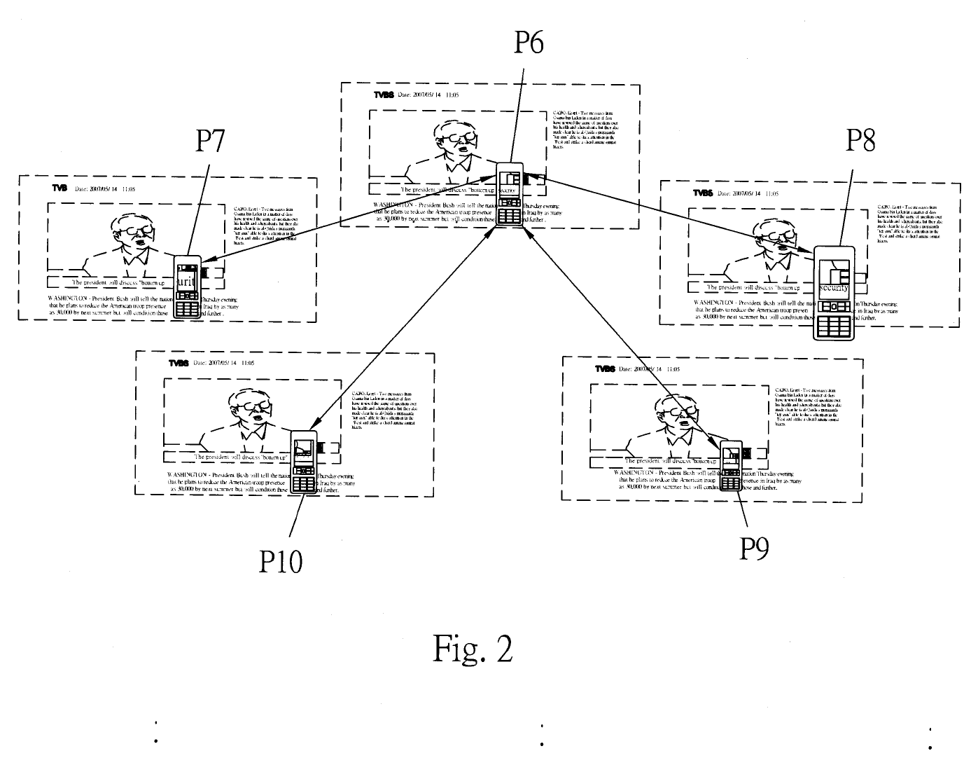

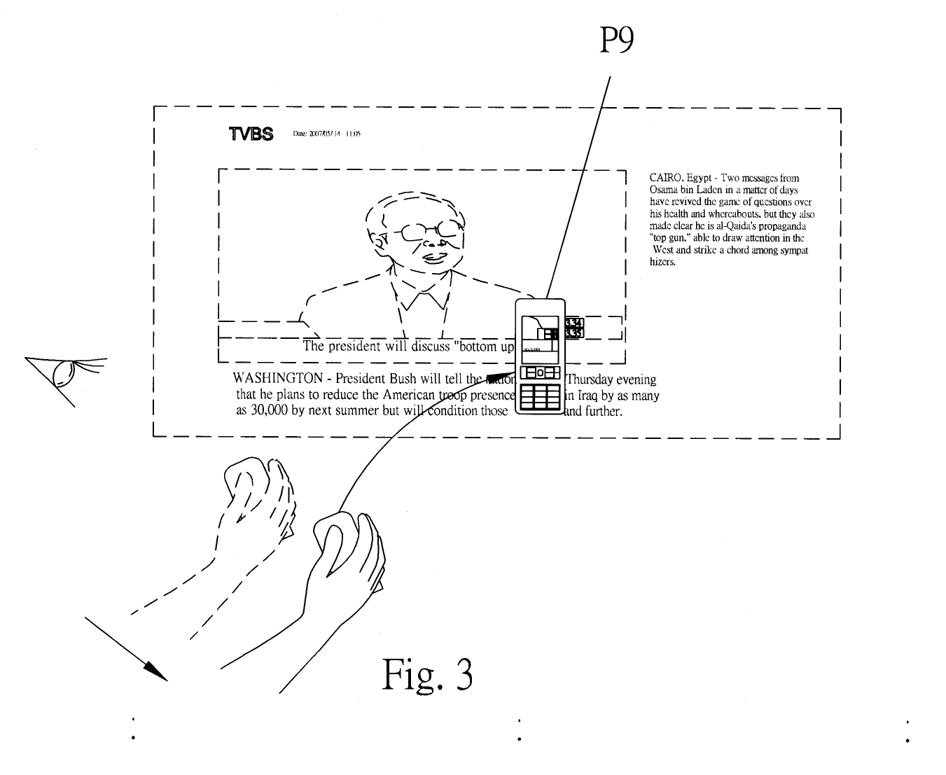

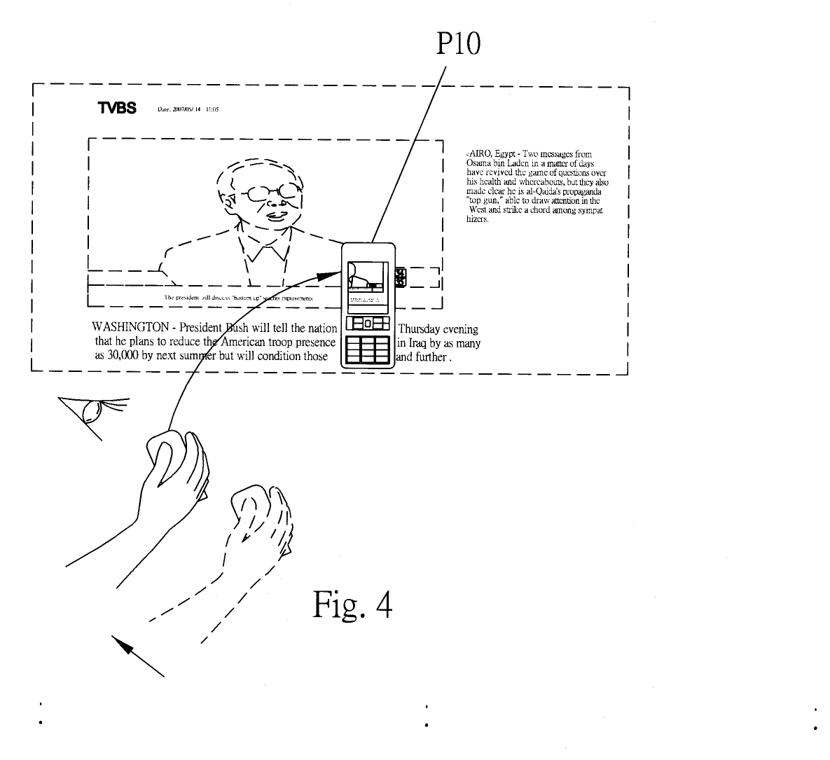

Referring to FIGS. 2, 3 and 4, the use of the present invention will be described herein.

P6: the handset presents a document with a normal mode.

P7: The zoom of the mobile device presented on the screen of a mobile device is enlarged by using the key of the handset.

P8: The size of the mobile device presented on the screen of a mobile device is reduced by using the key of the handset.

P9: The mobile device is moved backwards so shortening the distance between the mobile device and the document so as to enlarge the zoom of the document presented on the screen.

P10: The mobile device is moved forwards so shortening the distance between the mobile device and the document so as to reduce the zoom of the document presented on the screen.

Advantages of the present invention will be described herein.

1. Papers are saved so as to match the requirement of environmental protection.

2. The presentation of the document on the screen is identical to the real printed page without being limited by the size of the screen of the mobile device.

3. The user can move the mobile device to view any area of the document. The operation is vivid as viewing an image from a camera.

4. The document can be loaded from a network for reading.

5. All the documents can be converted into any desired image format (such as JPEG format) and then are stored in the memory of the mobile device for viewing by moving the mobile device to a corresponding zoom as a printed page.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A virtual paper reading device comprising:
a virtual paper reading device for viewing a document from a screen through a mobile device; wherein the document to be read has a size as an original size and an original printed page;
a 3 axial sensor in the mobile device for sensing moving direction of the mobile device;
a key set for adjusting a zoom of the document to be presented and a present area of the document to be presented; and
an application software for receiving the moving direction message from the 3 axial sensor and adjusting signals from the key set so as to adjust a present zoom and a size of the document to be presented on the screen of the mobile device.

2. The virtual paper reading device as claimed in claim 1, wherein the mobile device is one of a handset, a MP3 player, a electronic player, a camera, a mobile PC, an UMPC, a PDA, which presents a document as a virtual paper having an original size and printed page.

3. The virtual paper reading device as claimed in claim 1, wherein expansion, reduction and contrast, illumination of the size of the document are adjustable in the virtual paper reading device so as to have a preferred viewing effect to suit visual ability of the user.

4. The virtual paper reading device as claimed in claim 1, wherein the virtual paper reading device plays sound or background music about the document to be presented by using a music file therein.

5. The virtual paper reading device as claimed in claim 1, wherein the virtual paper reading device can operate a multi-functional operation interface without limitation of direction and a virtual frame so that the user can start, pause or stop reading of the document, the operation is easy, personal, and conveniently.

6. The virtual paper reading device as claimed in claim 1, wherein the virtual paper reading device is built with keyboard or keys for downloading data to provide a user.
